(19) United States
(12) Patent Application Publication
(10) Pub. No.: US 2025/0371190 A1
(43) Pub. Date: Dec. 4, 2025

(54) METHOD AND APPARATUS FOR REQUESTING DATA, DEVICE AND NON-TRANSITORY READABLE STORAGE MEDIUM

(71) Applicant: SUZHOU METABRAIN INTELLIGENT TECHNOLOGY CO., LTD., Suzhou, Jiangsu (CN)

(72) Inventors: Fuguo HOU, Suzhou, Jiangsu (CN); Zhongke YUAN, Suzhou, Jiangsu (CN); Kai ZHANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/876,148

(22) PCT Filed: May 31, 2023
(86) PCT No.: PCT/CN2023/097549

§ 371 Date: Dec. 17, 2024

(30) Foreign Application Priority Data
Nov. 16, 2022 (CN) 202211430815.4

(51) Int. Cl. G06F 21/62

(52) U.S. Cl. CPC G06F 21/6227

(57) ABSTRACT

The present disclosure discloses a method and apparatus for requesting data, a device and a non-transitory readable storage medium. The method is applied to a storage side and includes: a private query command sent by a host side is acquired; access priority information of each controller node on the storage side is generated according to the private query command, and the access priority information represents an access state of the controller node for a data segment having an access relationship therewith; and the access priority information of each controller node is sent to the host side, so that the host side requests data through one controller node according to the access priority information.

### CROSS-REFERENCE TO RELATED APPLICATION

The present application is a National Stage Application of PCT International Application No.: PCT/CN2023/097549 filed on May 31, 2023, which claims priority to Chinese Patent Application 202211430815.4, filed in the China National Intellectual Property Administration on Nov. 16, 2022, the disclosure of which is incorporated herein by reference in its entirety.

### TECHNICAL FIELD

The present disclosure relates to the technical field of storage, and in particular to a method and apparatus for requesting data, a device and a non-transitory readable storage medium.

### BACKGROUND

With the advent, data concentration is a product in the age of big data, and requirements for the stability and reliability of storage systems become higher and higher. At present, the storage systems mostly use a plurality of controllers to improve the storage efficiency, a multi-controller storage system receives a read data request from a host, the data request arrives at a rear-end disk through the controllers, and then is returned to the host; and if the data request is a write data request, the data request is written to the rear-end disk through the controllers. For the multi-controller storage system, particularly a one-frame four-controller storage system, there are four controller nodes under one control box, therefore it is necessary to use a proper strategy to determine to issue the data request to the disk through which controller. By using the proper strategy, load balancing between the host and the storage system is ensured, and the overall performance is improved. A traditional strategy usually specifies a most suitable node, and all inputs and outputs will be issued to the rear-end disk through this controller, and the other controllers have no input/output traffic, resulting in load imbalance, and the performance is reduced under a high load, thereby bringing extremely poor experience to a user, reducing the approval degree of the user for a product, and seriously wasting hardware resources.

Therefore, the above technical problems need to be urgently solved by those skilled in the art.

### SUMMARY

The present disclosure provides a method and apparatus for requesting data, a device and a non-transitory readable storage medium. The specific solution is as follows:

A first aspect of the present disclosure provides a method for requesting data, applied to a storage side, including:
a private query command sent by a host side is acquired;
access priority information of each controller node on the storage side is generated according to the private query command, and the access priority information represents an access state of the controller node for a data segment having an accessible relationship therewith; and
the access priority information of each controller node is sent to the host side, so that the host side requests data through one controller node according to the access priority information.

In some embodiments, the method for requesting data further includes:
a logical volume of the storage side is divided into a plurality of data segments; and
the accessible relationship is respectively established between the controller node and each data segment in a unit of each controller node on the storage side, and an access priority is set for each controller node according to all accessible relationships of each controller node.

In some embodiments, the logical volume of the storage side is divided into the plurality of data segments includes:
a logical namespace of the storage side is divided to obtain a plurality of namespace blocks corresponding to the logical namespace, and the logical namespace is one of logical volumes, and the namespace blocks are the data segments which are divided.

In some embodiments, after the logical volume of the storage side is divided into the plurality of data segments, the method further includes:
an optimal access relationship is established between each data segment and the controller node corresponding to the data segment; and
the access priority is set for each controller node according to all accessible relationships of each controller node and the optimal access relationship.

In some embodiments, data is requested by the host side through the controller node according to the access priority information includes:
one controller node in an optimal access state is determined by the host side for each data segment according to the access priority information, and data is requested by the host side through the controller node in the optimal access state.

In some embodiments, the controller node in the optimal access state is determined by the host side for each data segment according to the access priority information includes:
the controller node, which simultaneously has the optimal access relationship and the accessible relationship with the data segment, is determined by the host side as the controller node in the optimal state for the data segment; and
the controller node, which only has the accessible relationship with the data segment, is determined by the host side as the controller node in a non-optimal state for the data segment.

In some embodiments, the accessible relationship is respectively established between the controller node and each data segment in the unit of each controller node on the storage side includes:
storage stack strategy information for establishing the accessible relationship is acquired from a lower-layer storage stack, and the accessible relationship is established between the controller node and each data segment according to the storage stack strategy information.

In some embodiments, the access priority information includes data segment information, a data segment priority descriptor, and expansion information of the data segment priority descriptor.

In some embodiments, the private query command is a custom private command meeting a non-volatile memory express (NVMe).

A second aspect of the present disclosure provides a method for requesting data, applied to a host side, including:
a private query command is sent to a storage side, so that the storage side generates access priority information of each controller node on the storage side according to the private query command, and the access priority information represents an access state of the controller node for a data segment having an accessible relationship therewith; and
the access priority information sent by the storage side is received, and data is requested through one controller node according to the access priority information.

In some embodiments, before the private query command is sent to the storage side, the method further includes:
whether the storage side supports the private query command is judged, and in a case where the storage side supports the private query command, the private query command is sent to the storage side.

In some embodiments, whether the storage side supports the private query command is judged includes:
a discrimination instruction is generated, and the discrimination instruction is sent to the storage side; and
support information sent by the storage side is received, and in a case where the support information represents that the storage side supports a segment reporting mode, it is judged that the storage side supports the private query command.

A third aspect of the present disclosure provides an apparatus for requesting data, applied to a storage side, including:
a command acquisition module, configured to acquire a private query command sent by a host side;
an information generation module, configured to generate access priority information of each controller node on the storage side according to the private query command, and the access priority information represents an access state of the controller node for a data segment having an accessible relationship therewith; and
an information return module, configured to send the access priority information of each controller node to the host side, so that the host side requests data through one controller node according to the access priority information.

A fourth aspect of the present disclosure provides an apparatus for requesting data, applied to a host side, including:
a command sending module, configured to send a private query command a storage side, so that the storage side generates access priority information of each controller node on the storage side according to the private query command, and the access priority information represents an access state of the controller node for a data segment having an accessible relationship therewith; and
an information receiving and requesting module, configured to receive the access priority information sent by the storage side, and request data through one controller node according to the access priority information.

A fifth aspect of the present disclosure provides an electronic device, including a processor and a memory, and the memory is configured to store a computer program, and the computer program is loaded and executed by the processor to implement the foregoing method for requesting data.

A sixth aspect of the present disclosure provides a computer-readable non-transitory readable storage medium, and a computer-executable instruction is stored in the computer-readable non-transitory readable storage medium, and the computer-executable instruction, when loaded and executed by a processor, implements the foregoing method for requesting data.

### BRIEF DESCRIPTION OF THE DRAWINGS

To illustrate technical solutions in the embodiments of the present disclosure or in the prior art more clearly, a brief introduction on the drawings which are needed in the description of the embodiments or the prior art is given below. Apparently, the drawings in the description below are merely embodiments of the present disclosure, based on which other drawings may be obtained by those ordinary skilled in the art without any creative effort.

FIG. 1 is a flowchart of a method for requesting data on a storage side provided in the present disclosure;

FIG. 2 is a schematic diagram of a reference protocol for acquiring asymmetric namespace access (ANA) information through an original Get Log Page command provided in the present disclosure;

FIG. 3 is a schematic diagram of a reference protocol for acquiring asymmetric namespace access (ANA) information through an original Get Log Page command provided in the present disclosure;

FIG. 4 is a flowchart of a specific method for requesting data on a storage side provided in the present disclosure;

FIG. 5 is a flowchart of a specific method for requesting data on a storage side provided in the present disclosure;

FIG. 6 is a schematic diagram of a multi-path finally formed by a four-controller storage system provided in the present disclosure;

FIG. 7 is a schematic diagram of a format description of an Asymmetric Namespace Access Referrals Log command provided in the present disclosure;

FIG. 8 is a schematic diagram of an expanded description of Namespace Segment referral Info provided in the present disclosure;

FIG. 9 is a schematic diagram of an expanded description of a Namespace segment referral descriptor provided in the present disclosure;

FIG. 10 is a flowchart of a process of a host side performing data request according to access priority information provided in the present disclosure;

FIG. 11 is a flowchart of a method for requesting data on a host side provided in the present disclosure;

FIG. 12 is a flowchart of a specific method for requesting data on a host side provided in the present disclosure;

FIG. 13 is a schematic diagram of a specific interaction process between a host side and a storage side provided in the present disclosure;

FIG. 14 is a schematic structural diagram of an apparatus for requesting data on a storage side provided in the present disclosure;

FIG. 15 is a schematic structural diagram of an apparatus for requesting data on a host side provided in the present disclosure; and

FIG. 16 is a structural diagram of a data request electronic device provided in the present disclosure.

### DETAILED DESCRIPTION OF THE EMBODIMENTS

A clear and complete description of technical solutions in the embodiments of the present disclosure will be given below, in combination with the drawings in the embodiments of the present disclosure. Apparently, the embodiments described below are merely a part, but not all, of the embodiments of the present disclosure. All of other embodiments, obtained by those ordinary skilled in the art based on the embodiments in the present disclosure without any creative effort, fall into the protection scope of the present disclosure.

An existing multi-controller storage system often specifies a most suitable node, and all inputs and outputs will be issued to a rear-end disk through this controller, and the other controllers have no input/output traffic, resulting in load imbalance, and the performance is reduced under a high load, thereby bringing extremely poor experience to a user, reducing the approval degree of the user for a product, and seriously wasting hardware resources. In view of the above technical defects, the present disclosure provides a data request solution, which may implement load balancing between a host and a multi-controller storage by defining a private instruction, reduce storage hardware resources, and improve storage performance. in the data request solution, an access priority is set in the unit of a controller of the multi-controller storage system, a host side actively acquires the access priority of a control node on a storage side with respect to a data segment by sending a custom private query command, and thus may determine, on the basis of the access priority information, to use which controller to issue a data request to a rear-end disk of the storage side, thereby implementing load balancing of the multi-controller storage between the controllers, reducing storage hardware resources, and improving storage performance.

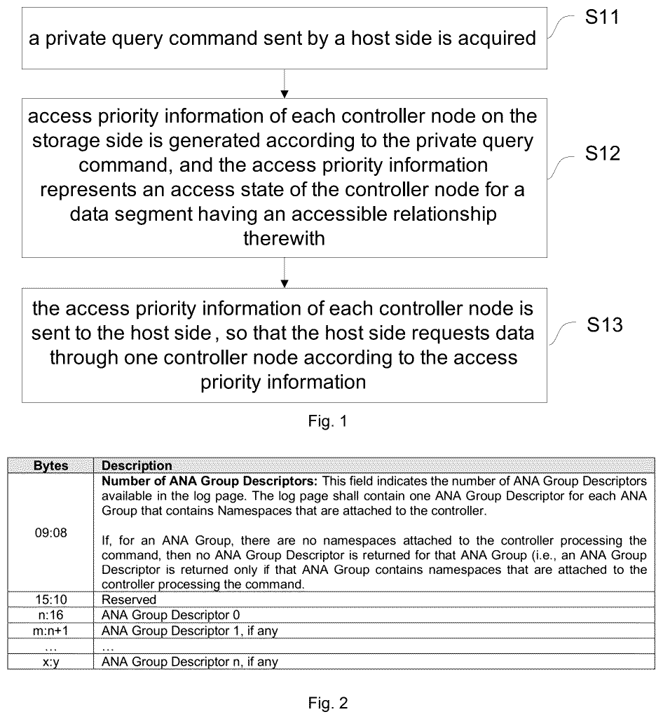

FIG. 1 is a flowchart of a method for requesting data provided in an embodiment of the present disclosure. As shown in FIG. 1, the method for requesting data is applied to a storage side, and includes:
S11: a private query command sent by a host side is acquired.

In the present embodiment, the storage side is a multi-controller storage system meeting a non-volatile memory express (NVMe), which is a multiple controller system (MCS), for example, the multiple controller system having four NVMe controllers is a four-controller storage system, the multiple controller system having two NVMe controllers is a two-controller storage system, and the four-controller storage system is generally used.

In the present embodiment, when the host side performs data request, the storage side firstly acquires the private query command sent by the host side, and the private query command is a custom private command meeting the non-volatile memory express (NVMe). For example, the private query command may be a redefined Get Log Page command, which is represented as an Asymmetric Namespace Access Referrals Log command. The Get Log Page command is a log page acquisition command, which returns a data buffer area containing a requested log page. The Get Log Page command may be affected by an ANA state. The Get Log Page command uses Data Pointer, Command Dword 10, Command Dword 11, Command Dword 12, Command Dword 13 and Command Dword 14 fields, and retains all other command specific fields.

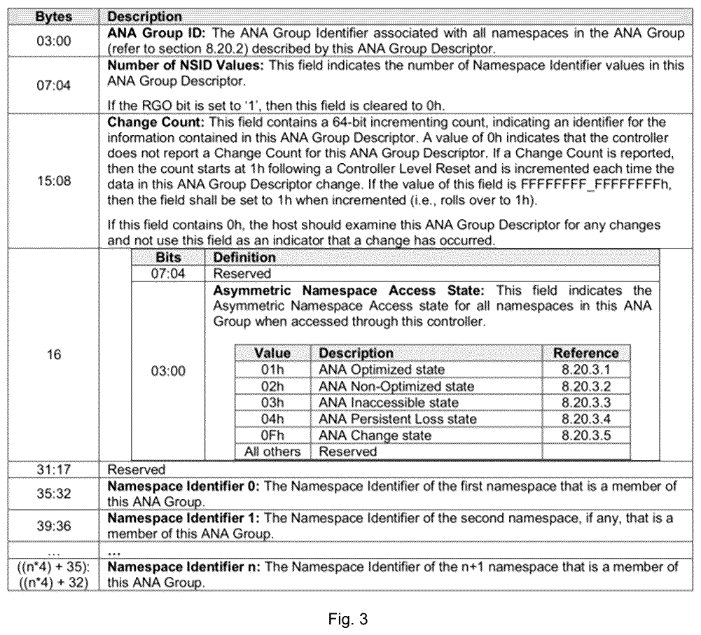

Tables in FIG. 2 and FIG. 3 show reference protocols for acquiring asymmetric namespace access (ANA) information through an original Get Log Page command, a host acquires the ANA information through the Get Log Page command, and a Log Identifier is 0Ch. Number of ANA Group Descriptors in the table in FIG. 2 indicates there are how many priority groups, each priority descriptor is list thereafter, and each descriptor is expanded in the second table. ANA Group ID represents the id of each group, Number of NSID Values indicates there are how many NSIDs in the group, that is, there are how many namespaces, Change Count represents the number of changes in the group, the priority of the group is identified then, and finally all NSIDs are listed. In a case where there is only one storage disk, when ANA access is performed through the above protocol, only a host port and a storage port corresponding to the storage disk have traffic, thus resulting in load imbalance, which is particularly obvious in the four-controller system, because there are three controllers having no traffic.
S12: access priority information of each controller node on the storage side is generated according to the private query command, and the access priority information represents an access state of the controller node for a data segment having an accessible relationship therewith.

In the present embodiment, after acquiring the private query command, the storage side generates the access priority information of each controller node on the storage side according to the private query command, and the access priority information represents the access state of the controller node for the data segment having the accessible relationship therewith, and a plurality of data segments constitute a storage disk of the storage side. The accessible relationship represents a relationship that may be accessed, that is, between the data segment and the controller node, which have the accessible relationship, the controller node may access the data segment. In addition, three controllers are specified in an NVMe protocol, the present embodiment only relates to an I/O Controller, and the remaining controllers are not described.
S13: the access priority information of each controller node is sent to the host side, so that the host side requests data through one controller node according to the access priority information.

In the present embodiment, after generating the access priority information, the storage side returns the access priority information of each controller node to the host side, so that the host side requests data according to the access priority information and through the corresponding controller node. When performing data access, the host side finds the most suitable controller node according to the data segment corresponding to a logical address of data to be accessed, so as to request the data from the data segment. In this way, the rear-end disk may be accessed by different controller nodes, thereby implementing load balancing between the host and the multi-controller storage.

It may be seen that in the embodiment of the present disclosure, the storage side firstly acquires the private query command sent by the host side; then the access priority information of each controller node on the storage side is generated according to the private query command, and the access priority information represents the access state of the controller node for the data segment having the accessible relationship therewith; and finally, the access priority information of each controller node is returned to the host side, so that the host side requests data according to the access priority information and through the corresponding controller node. In the embodiment of the present disclosure, the access priority is set in the unit of a controller of the multi-controller storage system, the host side actively acquires the access priority of the control node on the storage side with respect to the data segment by sending a custom private query command, and thus may determine, on the basis of the access priority information, to use which controller to issue a data request to a rear-end disk of the storage side, thereby implementing load balancing of the multi-controller storage between the controllers, reducing storage hardware resources, and improving storage performance.

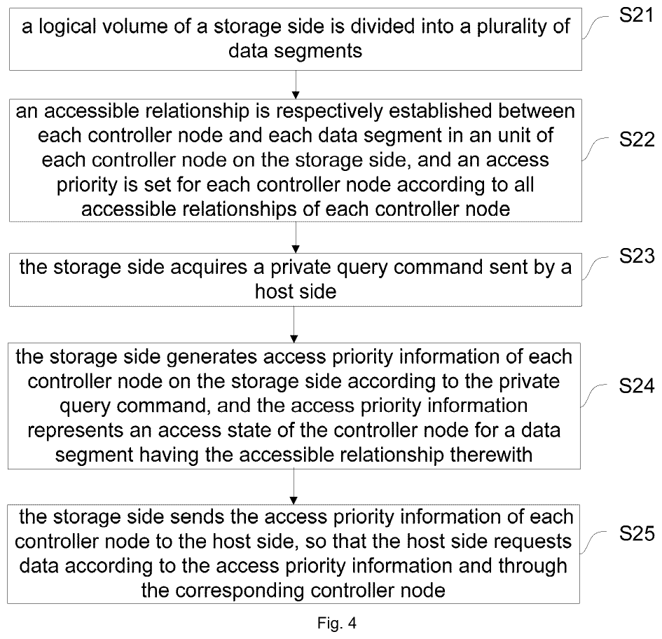

FIG. 4 is a flowchart of a specific method for requesting data provided in an embodiment of the present disclosure. As shown in FIG. 4, the method for requesting data includes:
S21: a logical volume of a storage side is divided into a plurality of data segments.
S22: an accessible relationship is respectively established between each controller node and each data segment in a unit of each controller node on the storage side, and an access priority is set for each controller node according to all accessible relationships of each controller node. In the present embodiment, in order to implement load balancing, the logical volume of the storage side needs to be divided into the plurality of data segments. A specific segment size may be set according to storage stack strategy information (IO stack strategy information) of a lower-layer storage stack (an IO stack), and may also be autonomously set according to service requirements. The specific segment size is generally set as 32M, that is, segmentation is performed according to a specification of 32M per segment, and the plurality of data segments are 0, 32M-1, 32M, 64M-1, 64M, 96M-1, 96M, 128M1, etc.

In the present embodiment, after segmentation is performed, it is also necessary to respectively establish the accessible relationship between the controller node and each data segment in the unit of each controller node on the storage side, and the accessible relationship may be established between each controller node and each data segment, so that each controller node may access the data segment, but it should be noted that the same data segment has only one optimal controller node, which is embodied on the access priority. On this basis, the access priority is set for each controller node according to all accessible relationships of the controller nodes. For example, the accessible relationships are present between a data segment 1 and a controller node 1, a controller node 2, a controller node 3 and a controller node 4, but the accessible relationship between the data segment 1 and the controller node 1 is more special, and then for the data segment 1, the access priority of the controller node 1 is the highest.
S23: the storage side acquires a private query command sent by a host side.
S24: the storage side generates access priority information of each controller node on the storage side according to the private query command, and the access priority information represents an access state of the controller node for a data segment having the accessible relationship therewith.
S25: the storage side sends the access priority information of each controller node to the host side, so that the host side requests data according to the access priority information and through the corresponding controller node.

With regard to the specific process of the step S23 to the step S25, reference may be made to corresponding content disclosed in the foregoing embodiments, and thus details are not described herein again.

It may be seen that in the embodiment of the present disclosure, the logical volume of the storage side is firstly divided into the plurality of data segments, then the accessible relationship is respectively established between the controller node and each data segment in the unit of each controller node on the storage side, and the access priority is set for each controller node according to all accessible relationships of the controller nodes. On this basis, the storage side acquires the private query command sent by the host side, and generates the access priority information of each controller node on the storage side according to the private query command, and the access priority information represents the access state of the controller node for the data segment having the accessible relationship therewith, and the storage side returns the access priority information of each controller node to the host side, so that the host side requests data according to the access priority information and through the corresponding controller node. In the embodiment of the present disclosure, the access priority is set in the unit of the controller of the multi-controller storage system on the basis of segmenting the rear-end disk of the storage side, thereby implementing load balancing of the multi-controller storage between the controllers.

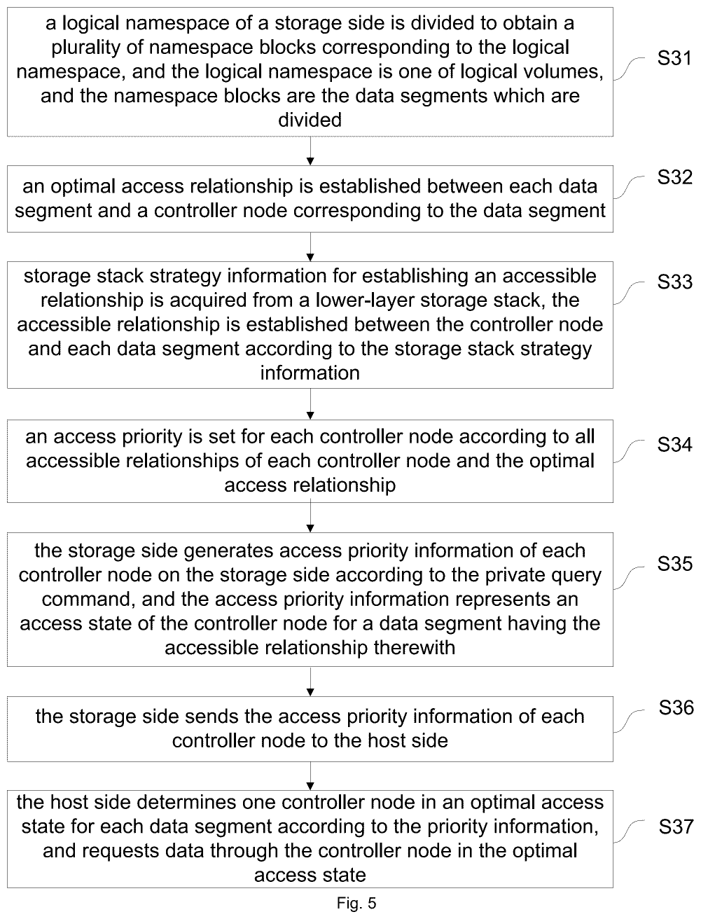

FIG. 5 is a flowchart of a specific method for requesting data provided in an embodiment of the present disclosure. As shown in FIG. 5, the method for requesting data includes:
S31: a logical namespace of a storage side is divided to obtain a plurality of namespace blocks corresponding to the logical namespace, and the logical namespace is one of logical volumes, and the namespace blocks are the data segments which are divided.
S32: an optimal access relationship is established between each data segment and a controller node corresponding to the data segment.
S33: storage stack strategy information for establishing an accessible relationship is acquired from a lower-layer storage stack, the accessible relationship is established between the controller node and each data segment according to the storage stack strategy information.
S34: an access priority is set for each controller node according to all accessible relationships of each controller node and the optimal access relationship.

In the present embodiment, the logical volume is a logical namespace, and the logical namespace of the storage side is divided to obtain the plurality of namespace blocks corresponding to the logical namespace, and the logical namespace is one of logical volumes, and the namespace blocks are the data segments which are divided. Then, the optimal access relationship is established between each data segment and the corresponding controller node, and the optimal access relationship represents which controller node has the highest access priority for a certain data segment. For example, with regard to load balancing in a scenario of a single logical namespace of 128M, each logical namespace is divided into four groups according to a segment size of 32M, each group is preferentially accessed by one controller node and is non-preferentially accessed by other controller nodes. The optimal access relationship is 0, 32M-1: node 1, 32M, 64M-1: node 2, 64M, 96M-1: node 3, 96M, 128M-1: node 4.

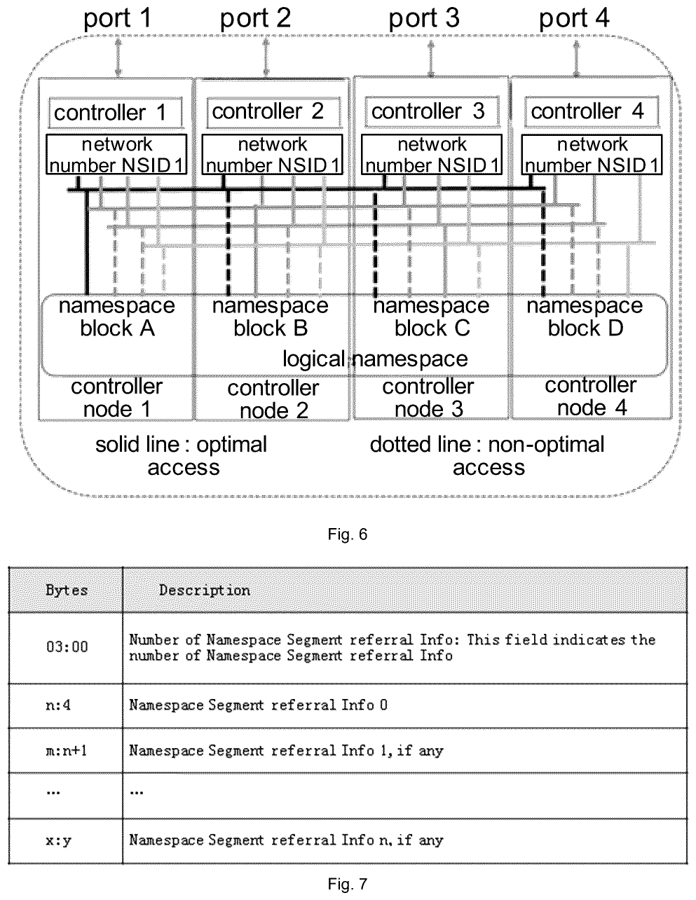

In the present embodiment, it is also necessary to acquire the storage stack strategy information (IO stack strategy information) for establishing the accessible relationship from a lower-layer input/output stack, and to establish the accessible relationship between the controller node and each data segment according to the storage stack strategy information (the IO stack strategy information). Finally, the access priority is set for each controller node according to all accessible relationships of the controller nodes and the optimal access relationship. Taking a four-controller storage system as an example, the finally achieved effect is shown in FIG. 6 (there is only one namespace). The namespace is divided into four data segments: Block A, Block B, Block C and Block D. A solid line indicates optimal access, and a dotted line indicates non-optimal access.
S35: the storage side generates access priority information of each controller node on the storage side according to the private query command, and the access priority information represents an access state of the controller node for a data segment having the accessible relationship therewith.

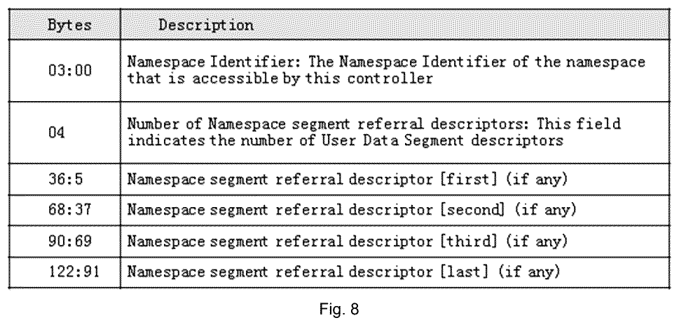

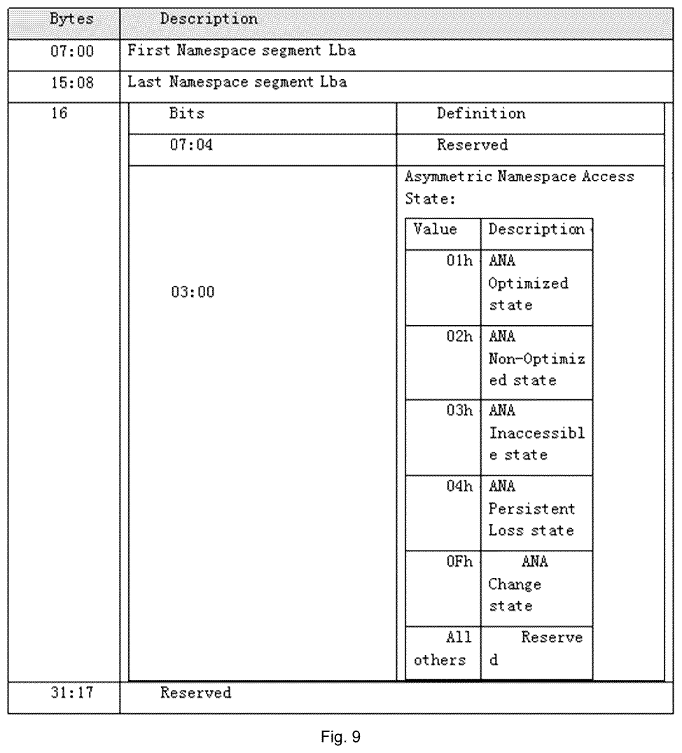

In the present embodiment, under the private query command, the returned priority information includes data segment information, a data segment priority descriptor, and expansion information of the data segment priority descriptor. Under the namespace, the command needs to describe the access priority information for segmenting all namespaces under each controller, and for details, reference may be made to the following three tables in FIG. 7 to FIG. 9. The table in FIG. 7 is a format description of an Asymmetric Namespace Access Referrals Log command, and the number of Namespace Segment referral Info is the same as the number of namespaces; the table in FIG. 8 is an expansion of the Namespace Segment referral Info, which represents a priority descriptor of a segment corresponding to each namespace; and the table in FIG. 9 is an expansion of a Namespace segment referral descriptor, in which the access priority information of the segment is described. That is, the data segment information is shown in the table in FIG. 7, the table in FIG. 8 is the expansion of the data segment information, that is, the data segment priority descriptor, and the table in FIG. 9 is the expansion information of the data segment priority descriptor. The data segment priority descriptor, i.e., a data segment descriptor, is a data structure, which provides a processor with the size and location of the data segment and control and state information. Typically, the data segment descriptor is generated by a compiler, a connector, a loader, or an operating system, rather than an application program.
S36: the storage side sends the access priority information of each controller node to the host side.

In the present embodiment, with regard to the specific process of the step S36, reference may be made to corresponding content disclosed in the foregoing embodiments, and thus details are not described herein again.
S37: the host side determines one controller node in an optimal access state for each data segment according to the access priority information, and requests data through the controller node in the optimal access state.

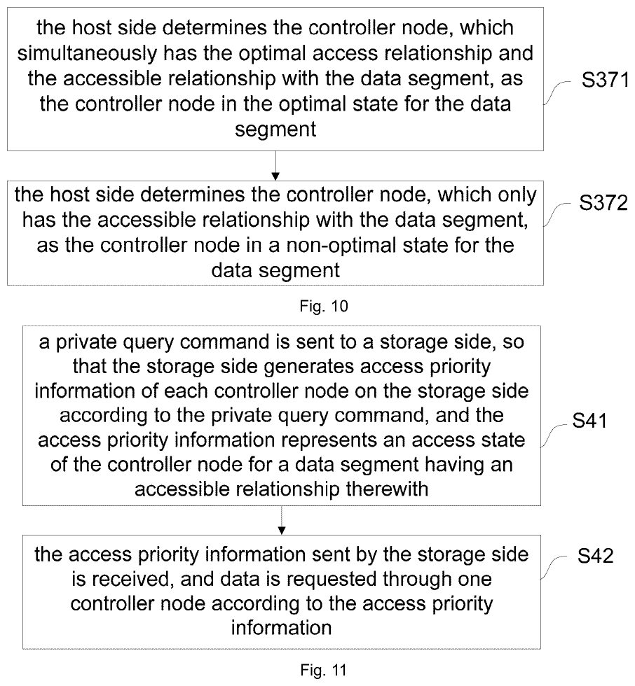

In the present embodiment, the host side determines the controller node in the optimal access state for each data segment according to the access priority information, and requests data through the controller node in the optimal access state. The data request process is shown in FIG. 10, and the specific steps are as follows:
S371: the host side determines the controller node, which simultaneously has the optimal access relationship and the accessible relationship with the data segment, as the controller node in the optimal state for the data segment.
S372: the host side determines the controller node, which only has the accessible relationship with the data segment, as the controller node in a non-optimal state for the data segment.

In the present embodiment, in the optimal access state, the host side determines the controller node, which simultaneously has the optimal access relationship and the accessible relationship with the data segment, as the controller node in the optimal state for the data segment. In the non-optimal state, the host side determines the controller node, which only has the accessible relationship with the data segment, as a controller node in the non-optimal state for the data segment.

It may be seen that in the embodiment of the present disclosure, the logical namespace of the storage side is firstly divided to obtain the plurality of namespace blocks corresponding to the logical namespace, and the logical namespace is one of logical volumes, and the namespace blocks are the data segments which are divided. Then, the optimal access relationship is established between each data segment and the corresponding controller node. Meanwhile, the storage stack strategy information for establishing the accessible relationship is acquired from the lower-layer storage stack, the accessible relationship is established between the controller node and each data segment according to the storage stack strategy information. Finally, the access priority is set for each controller node according to all accessible relationships of the controller nodes and the optimal access relationship. In this way, load balancing under an asymmetric namespace is implemented.

FIG. 11 is a flowchart of a method for requesting data provided in an embodiment of the present disclosure. As shown in FIG. 11, the method for requesting data is applied to a host side, and includes:
S41: a private query command is sent to a storage side, so that the storage side generates access priority information of each controller node on the storage side according to the private query command, and the access priority information represents an access state of the controller node for a data segment having an accessible relationship therewith.

In the present embodiment, the host side firstly sends the private query command to the storage side. The storage side is a multi-controller storage system meeting a non-volatile memory express (NVMe), which is a multiple controller system (MCS), for example, the multiple controller system having four NVMe controllers is a four-controller storage system, the multiple controller system having two controllers is a two-controller storage system, and the four-controller storage system is generally used.

In the present embodiment, when the host side performs data request, the storage side firstly acquires the private query command sent by the host side, and the private query command is a custom private command meeting the non-volatile memory express (NVMe). For example, the private query command may be a redefined Get Log Page command, which is represented as an Asymmetric Namespace Access Referrals Log command. The Get Log Page command is a log page acquisition command, which returns a data buffer area containing a requested log page. The Get Log Page command may be affected by an ANA state. The Get Log Page command uses Data Pointer, Command Dword 10, Command Dword 11, Command Dword 12, Command Dword 13 and Command Dword 14 fields, and retains all other command specific fields.

In the present embodiment, after acquiring the private query command, the storage side generates the access priority information of each controller node on the storage side according to the private query command. Then, after generating the access priority information, the storage side returns the access priority information of each controller node to the host side, and the access priority information represents the access state of the controller node for the data segment having the accessible relationship therewith, and a plurality of data segments constitute a storage disk of the storage side. The accessible relationship represents a relationship that may be accessed, that is, between the data segment and the controller node, which have the accessible relationship, the controller node may access the data segment. In addition, three controllers are specified in the NVMe protocol, the present embodiment only relates to an I/O Controller, and the remaining controllers are not described.
S42: the access priority information sent by the storage side is received, and data is requested through one controller node according to the access priority information.

In the present embodiment, the host side receives the access priority information returned by the storage side, and requests data according to the access priority information and through the corresponding controller node. When performing data access, the host side finds the most suitable controller node according to the data segment corresponding to a logical address of data to be accessed, so as to request the data from the data segment. In this way, the rear-end disk may be accessed by different controller nodes, thereby implementing load balancing between the host and the multi-controller storage.

It may be seen that in the embodiment of the present disclosure, the host side firstly sends the private query command to the storage side, so that the storage side generates the access priority information of each controller node on the storage side according to the private query command, and the access priority information represents the access state of the controller node for the data segment having the accessible relationship therewith; and then the access priority information returned by the storage side is received, and data is requested according to the access priority information and through the corresponding controller node. In the embodiment of the present disclosure, the access priority is set in the unit of a controller of the multi-controller storage system, the host side actively acquires the access priority of the control node on the storage side with respect to the data segment by sending a custom private query command, and thus may determine, on the basis of the access priority information, to use which controller to issue a data request to a rear-end disk of the storage side, thereby implementing load balancing of the multi-controller storage between the controllers, reducing storage hardware resources, and improving storage performance.

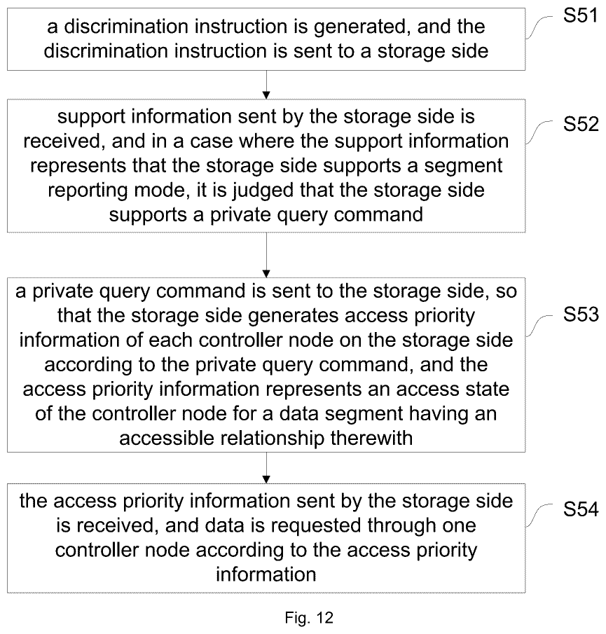

FIG. 12 is a flowchart of a specific method for requesting data provided in an embodiment of the present disclosure. As shown in FIG. 12, the method for requesting data is applied to a host side, and includes:
S51: a discrimination instruction is generated, and the discrimination instruction is sent to a storage side.
S52: support information sent by the storage side is received, and in a case where the support information represents that the storage side supports a segment reporting mode, it is judged that the storage side supports a private query command.

In the present embodiment, before sending the private query command, the host side needs to judge whether the storage side supports the private query command, and if so, sends the private query command to the storage side. Specifically, the discrimination instruction is generated at first, then the discrimination instruction is sent to the storage side, the storage side will return corresponding support information, then the support information returned by the storage side is received, and if the support information represents that the storage side supports the segment reporting mode, it is judged that the storage side supports the private query command.

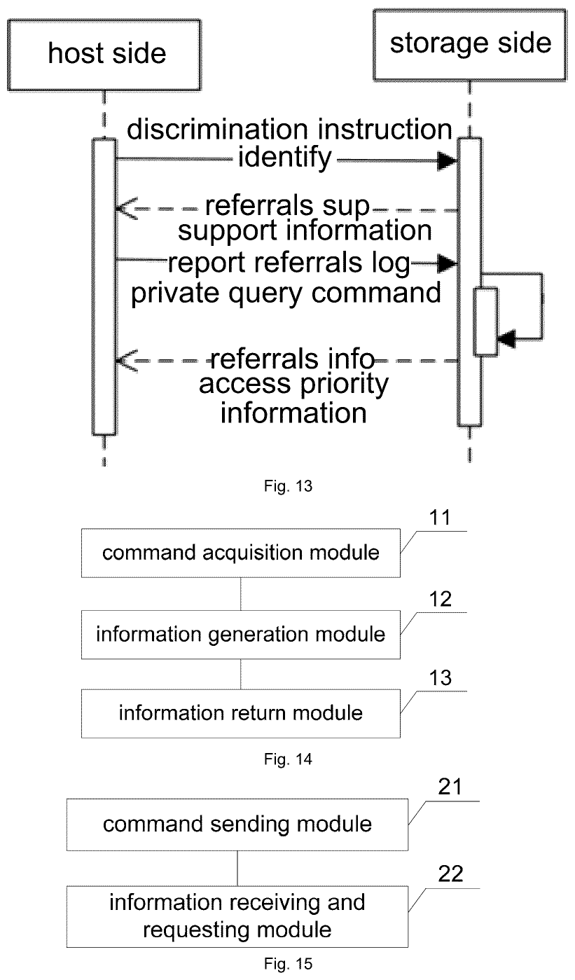

A specific interaction process between the host side and the storage side is as shown in FIG. 13, the host side firstly queries, by the discrimination instruction, whether the storage side supports the segment reporting mode, and the discrimination instruction may be an Identify command. If the storage side supports the characteristic, the host side requests a report ANA referrals Log, and the storage side target returns an Asymmetric Namespace Access Referrals Log. In addition, the referrals info returned to the host by the storage side is acquired by a storage front end from a lower-layer IO stack, and which segment may access which controller node for processing is specifically determined by the lower layer of the IO stack.
S53: a private query command is sent to the storage side, so that the storage side generates access priority information of each controller node on the storage side according to the private query command, and the access priority information represents an access state of the controller node for a data segment having an accessible relationship therewith.
S54: the access priority information sent by the storage side is received, and data is requested through one controller node according to the access priority information.

In the present embodiment, with regard to the specific process of the step S53 and the step S54, reference may be made to corresponding content disclosed in the foregoing embodiments, and thus details are not described herein again.

Referring to FIG. 14, an embodiment of the present disclosure further correspondingly discloses an apparatus for requesting data, applied to a storage side, including:
a command acquisition module 11, configured to acquire a private query command sent by a host side;
an information generation module 12, configured to generate access priority information of each controller node on the storage side according to the private query command, and the access priority information represents an access state of the controller node for a data segment having an accessible relationship therewith; and
an information return module 13, configured to send the access priority information of each controller node to the host side, so that the host side requests data through one controller node according to the access priority information.

It may be seen that in the embodiment of the present disclosure, the storage side firstly acquires the private query command sent by the host side; then the access priority information of each controller node on the storage side is generated according to the private query command, and the access priority information represents the access state of the controller node for the data segment having the accessible relationship therewith; and finally, the access priority information of each controller node is returned to the host side, so that the host side requests data according to the access priority information and through the corresponding controller node. In the embodiment of the present disclosure, the access priority is set in the unit of a controller of a multi-controller storage system, the host side actively acquires the access priority of the control node on the storage side with respect to the data segment by sending a custom private query command, and thus may determine, on the basis of the access priority information, to use which controller to issue a data request to a rear-end disk of the storage side, thereby implementing load balancing of the multi-controller storage between the controllers, reducing storage hardware resources, and improving storage performance.

In some specific embodiments, the apparatus for requesting data further includes:
a division module, configured to divide a logical volume of the storage side into a plurality of data segments;
a relationship establishment module, configured to respectively establish the accessible relationship between the controller node and each data segment in a unit of each controller node on the storage side;
a priority setting module, configured to set an access priority for each controller node according to all accessible relationships of each controller node;
a node determination module, configured to determine, by the host side, one controller node in an optimal access state for each data segment according to the access priority information; and
a data request module, configured to request, by the host side, data through the controller node in the optimal access state from the data segment corresponding to the controller node.

In some specific embodiments, the relationship establishment module is further configured to establish an optimal access relationship between each data segment and the controller node corresponding to the data segment; and
correspondingly, the priority setting module is further configured to set the access priority for each controller node according to all accessible relationships of each controller node and the optimal access relationship.

In some specific embodiments, the division module is further specifically configured to divide a logical namespace of the storage side to obtain a plurality of namespace blocks corresponding to the logical namespace, and the logical namespace is one of logical volumes, and the namespace blocks are the data segments which are divided.

In some specific embodiments, the node determination module specifically includes: a first determination unit, configured to determine, by the host side, the controller node, which simultaneously has the optimal access relationship and the accessible relationship with the data segment, as the controller node in the optimal state for the data segment; and a second determination unit, configured to determine, by the host side, the controller node, which only has the accessible relationship with the data segment, as the controller node in a non-optimal state for the data segment.

Referring to FIG. 15, an embodiment of the present disclosure further correspondingly discloses an apparatus for requesting data, applied to a host side, including:
a command sending module 21, configured to send a private query command to a storage side, so that the storage side generates access priority information of each controller node on the storage side according to the private query command, and the access priority information represents an access state of the controller node for a data segment having an accessible relationship therewith; and
an information receiving and requesting module 22, configured to receive the access priority information sent by the storage side, and request data through one controller node according to the access priority information.

It may be seen that in the embodiment of the present disclosure, the host side firstly sends the private query command to the storage side, so that the storage side generates the access priority information of each controller node on the storage side according to the private query command, and the access priority information represents the access state of the controller node for the data segment having the accessible relationship therewith; and then the access priority information returned by the storage side is received, and data is requested according to the access priority information and through the corresponding controller node. In the embodiment of the present disclosure, the access priority is set in the unit of a controller of a multi-controller storage system, the host side actively acquires the access priority of the control node on the storage side with respect to the data segment by sending a custom private query command, and thus may determine, on the basis of the access priority information, to use which controller to issue a data request to a rear-end disk of the storage side, thereby implementing load balancing of the multi-controller storage between the controllers, reducing storage hardware resources, and improving storage performance.

In some specific embodiments, the apparatus for requesting data further includes: a judging module, configured to judge whether the storage side supports the private query command, and if so, send the private query command to the storage side.

In some specific embodiments, the judging module specifically includes:
an instruction generating and sending unit, configured to generate a discrimination instruction and send the discrimination instruction to the storage side; and
a support information receiving unit, configured to receive support information sent by the storage side, and in a case where the support information represents that the storage side supports a segment reporting mode, judge that the storage side supports the private query command.

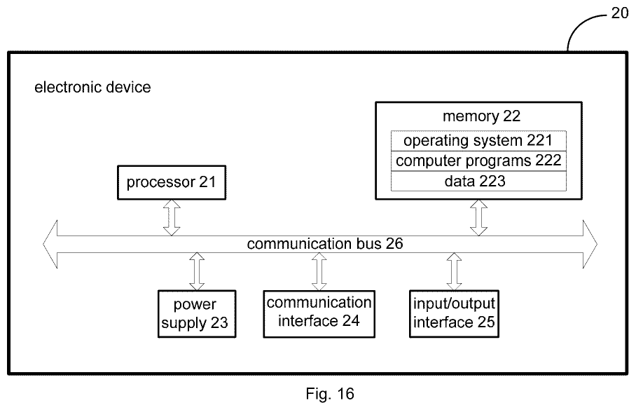

Further, an embodiment of the present disclosure further provides an electronic device. FIG. 16 is a structural diagram illustrating an electronic device 20 according to an exemplary embodiment, and the content in the figure may not be considered as any limitation to the usage scope of the present disclosure.

FIG. 16 is a schematic structural diagram of an electronic device 20 provided in an embodiment of the present disclosure. The electronic device 20 may specifically include: at least one processor 21, at least one memory 22, a power supply 23, a communication interface 24, an input/output interface 25, and a communication bus 26, and the memory 22 is configured to store a computer program, and the computer program is loaded and executed by the processor 21 to implement related steps in the method for requesting data disclosed in any of foregoing embodiments.

In the present embodiment, the power supply 23 is configured to provide an operating voltage for each hardware device on the electronic device 20; the communication interface 24 may create a data transmission channel with an external device for the electronic device 20, and a communication protocol followed by the communication interface 24 is any communication protocol that may be applicable to the technical solutions of the present disclosure, which is not specifically limited herein; and the input/output interface 25 is configured to acquire external input data or output data to the outside, and a specific interface type thereof may be selected according to specific application requirements, which is not specifically limited herein.

In addition, the memory 22, serving as a carrier for resource storage, may be a read-only memory, a random access memory, a magnetic disk, an optical disk, or the like, and resources stored thereon may include an operating system 221, computer programs 222, data 223, and the like, and the storage manner may be transient storage or permanent storage.

The operating system 221 is configured to manage and control hardware devices and the computer programs 222 on the electronic device 20 to implement operation and processing of the mass data 223 in the memory 22 by the processor 21, and the operating system 221 may be Windows Server, Netware, Unix, Linux, and the like. In addition to computer programs capable of completing the method for requesting data executed by the electronic device 20 disclosed in any of the foregoing embodiments, the computer programs 222 may further include computer programs capable of completing other specific operations. The data 223 may include access priority information collected by the electronic device 20.

Further, an embodiment of the present disclosure further discloses a non-transitory readable storage medium, and a computer program is stored in the non-transitory readable storage medium, and the computer program, when loaded and executed by a processor, implements the steps of the method for requesting data disclosed in any of the foregoing embodiments.

Various embodiments in the present specification are described in a progressive manner, what is highlighted in each embodiment is difference with other embodiments, and the identical or similar parts between the various embodiments refer to each other. With regard to the apparatus disclosed in the embodiments, it corresponds to the method disclosed in the embodiments, thus is described simply, and related parts may refer to the description of the method.

Finally, it should also be noted that herein, relational terms, such as first and second, are merely used for distinguishing one entity or operation from another entity or operation, and do not necessarily require or imply that any such actual relationship or order exists between these entities or operations. Moreover, the terms “include”, “contain” or any other variants thereof are intended to cover non-exclusive inclusions, such that a process, a method, an article or a device including a series of elements not only includes those elements, but also includes other elements that are not explicitly listed, or also includes elements inherent to such a process, method, article or device. If there are no more restrictions, the element defined by the sentence “including a . . . ” does not exclude the existence of other identical elements in the process, the method, the article or the device that includes the element.

The method and apparatus for requesting data, device and non-transitory readable storage medium provided in the present disclosure have been described in detail above, and specific examples are used herein to describe the principles and embodiments of the present disclosure, and the descriptions of the above embodiments are only used to help understand the method of the present disclosure and the core idea thereof; and meanwhile, for those ordinary skilled in the art, according to the idea of the present disclosure, there may be changes in specific embodiments and application ranges, and in summary, the content of the present specification should not be construed as limiting the present disclosure.

1. A method for requesting data, applied to a storage side, comprising:
acquiring a private query command sent by a host side;
generating access priority information of each controller node on the storage side according to the private query command, wherein the access priority information represents an access state of the controller node for a data segment having an accessible relationship therewith; and
sending the access priority information of each controller node to the host side, so that the host side requests data through one controller node according to the access priority information.

2. The method for requesting data according to claim 1, the method further comprising:
dividing a logical volume of the storage side into a plurality of data segments; and
respectively establishing the accessible relationship between the controller node and each data segment in a unit of each controller node on the storage side, and setting an access priority for each controller node according to all accessible relationships of each controller node.

3. The method for requesting data according to claim 2, wherein dividing the logical volume of the storage side into the plurality of data segments comprises: dividing a logical namespace of the storage side to obtain a plurality of namespace blocks corresponding to the logical namespace, wherein the logical namespace is one of logical volumes, and the namespace blocks are the data segments which are divided.

4. The method for requesting data according to claim 2, wherein after dividing the logical volume of the storage side into the plurality of data segments, the method further comprises:
establishing an optimal access relationship between each data segment and the controller node corresponding to the data segment; and
setting the access priority for each controller node according to all accessible relationships of each controller node and the optimal access relationship.

5. The method for requesting data according to claim 4, wherein requesting, by the host side, data through the controller node according to the access priority information comprises:
determining, by the host side, one controller node in an optimal access state for each data segment according to the access priority information, and requesting, by the host side, data through the controller node in the optimal access state.

6. The method for requesting data according to claim 5, wherein determining, by the host side, the controller node in the optimal access state for each data segment according to the access priority information comprises:
determining, by the host side, the controller node, which simultaneously has the accessible relationship and the optimal access relationship with the data segment, as the controller node in the optimal state for the data segment; and
determining, by the host side, the controller node, which only has the accessible relationship with the data segment, as the controller node in a non-optimal state for the data segment.

7. The method for requesting data according to claim 2, wherein respectively establishing the accessible relationship between the controller node and each data segment in the unit of each controller node on the storage side comprises:
acquiring, from a lower-layer storage stack, storage stack strategy information for establishing the accessible relationship, and establishing the accessible relationship between the controller node and each data segment according to the storage stack strategy information.

8. The method for requesting data according to claim 1, wherein the access priority information comprises data segment information, a data segment priority descriptor, and expansion information of the data segment priority descriptor.

9. The method for requesting data according to claim 1, wherein the private query command is a custom private command meeting a non-volatile memory express (NVMe).

10. The method for requesting data according to claim 1, the method further comprising:
dividing a logical namespace of the storage side to obtain a plurality of namespace blocks corresponding to the logical namespace, wherein the logical namespace is one of logical volumes of the storage side, and the namespace blocks are the data segments which are divided;
establishing an optimal access relationship between each data segment and the controller node corresponding to the data segment;
acquiring, from a lower-layer storage stack, storage stack strategy information for establishing the accessible relationship, and establishing the accessible relationship between the controller node and each data segment according to the storage stack strategy information; and
setting an access priority for each controller node according to all accessible relationships of each controller node and the optimal access relationship.

11. The method for requesting data according to claim 10, wherein a size of the data segment is set according to one of the following: the storage stack strategy information of the lower-layer storage stack, or service requirements.

12. The method for requesting data according to claim 1, wherein the storage side is a multi-controller storage system meeting the non-volatile memory express (NVMe), the private query command is a custom private command meeting the NVMe and the private query instruction comprises a log page acquisition command.

13. A method for requesting data, applied to a host side, comprising:
sending a private query command to a storage side, so that the storage side generates access priority information of each controller node on the storage side according to the private query command, wherein the access priority information represents an access state of the controller node for a data segment having an accessible relationship therewith; and
receiving the access priority information sent by the storage side, and requesting data through one controller node according to the access priority information.

14. The method for requesting data according to claim 13, wherein before sending the private query command to the storage side, the method further comprises: judging whether the storage side supports the private query command, and in a case where the storage side supports the private query command, sending the private query command to the storage side.

15. The method for requesting data according to claim 13, wherein judging whether the storage side supports the private query command comprises:
generating a discrimination instruction and sending the discrimination instruction to the storage side; and
receiving support information sent by the storage side, and in a case where the support information represents that the storage side supports a segment reporting mode, judging that the storage side supports the private query command.

16. The method for requesting data according to claim 13, wherein requesting data through the controller node according to the access priority information comprises:
determining one controller node in an optimal access state for each data segment according to the access priority information, and requesting data through the controller node in the optimal access state.

17. The method for requesting data according to claim 16, wherein determining the controller node in the optimal access state for each data segment according to the access priority information, and requesting data through the controller node in the optimal access state comprises:
determining the controller node, which simultaneously has the optimal access relationship and the accessible relationship with the data segment, as the controller node in the optimal state for the data segment; and
determining the controller node, which only has the accessible relationship with the data segment, as the controller node in a non-optimal state for the data segment.

18. (canceled)

19. An electronic device, comprising a processor and a memory, wherein the memory is configured to store a computer program, and the computer program is loaded and executed by the processor to implement the method for requesting data according to claim 1.

20. A computer-readable non-transitory readable storage medium, configured to store a computer-executable instruction, wherein the computer-executable instruction, when loaded and executed by a processor, is configured to cause the processor to:
acquire a private query command sent by a host side;
generate access priority information of each controller node on the storage side according to the private query command, wherein the access priority information represents an access state of the controller node for a data segment having an accessible relationship therewith; and
send the access priority information of each controller node to the host side, so that the host side requests data through one controller node according to the access priority information.

21. The method for requesting data according to claim 7, wherein a size of the data segment is set according to one of the following: the storage stack strategy information of the lower-layer storage stack, or service requirements.
